(19) United States
(12) Patent Application Publication
(10) Pub. No.: US 2013/0340086 A1
(43) Pub. Date: Dec. 19, 2013

(54) METHOD AND APPARATUS FOR PROVIDING CONTEXTUAL DATA PRIVACY

(71) Applicant: Jan Otto Blom, Lutry (CH)

(72) Inventor: Jan Otto Blom, Lutry (CH)

(73) Assignee: Nokia Corporation, Espoo (FI)

(21) Appl. No.: 13/495,156

(22) Filed: Jun. 13, 2012

(51) Int. Cl. G06F 21/00

(52) U.S. Cl. 726/26

(57) ABSTRACT

An approach is presented for providing privacy protection for data associated with a user and/or a user device. The approach includes aggregating data associated with one or more modalities of a user device; determining one or more categories of richness for the data associated with each one of the one or more modalities, wherein the richness is indicative of one or more parameters associated with the data user information, or a combination thereof; and determining a user privacy vulnerability level based, at least in part, on the one or more categories of richness.

### BACKGROUND

Service providers and device manufacturers (e.g., wireless, cellular, etc.) are continually challenged to deliver value and convenience to consumers by, for example, providing increasingly popular network applications, services, or a combination thereof that utilize contextual data collected and uploaded by mobile devices. For example, location data can be shared in real-time by mobile device users to receive location-based services and/or to provide their location information to their friends, families, and social networking services. Location is just one modality of context data that can be collected and uploaded to a service provider. In fact, today's mobile devices can be equipped with a range of sensors enabling the capturing of an assortment of information, e.g., audio, visual, temporal, and/or acceleration data, and in the future, the range of sensors will be even broader. However, privacy concerns associated with sharing contextual data or other potentially sensitive data and the disposition to share data with a service provider likely vary between users. Accordingly, service providers and device manufactures face significant technical challenges to allow users to make informed decisions regarding their individual data sharing, while also presenting them with the benefits to be gained from increased data sharing.

### SOME EXAMPLE EMBODIMENTS

Therefore, there is a need for an approach for providing contextual data privacy.

According to one embodiment, a method comprises causing, at least in part, an aggregation of data associated with one or more modalities of a user device. The method also comprises determining one or more categories of richness for the data associated with each one of the one or more modalities, wherein the richness is indicative of one or more parameters associated with the data user information, or a combination thereof. The method further comprises determining a user privacy vulnerability level based, at least in part, on the one or more categories of richness.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, an aggregation of data associated with one or more modalities of a user device. The apparatus is also caused to determine one or more categories of richness for the data associated with each one of the one or more modalities, wherein the richness is indicative of one or more parameters associated with the data user information, or a combination thereof. The apparatus is further caused to determine a user privacy vulnerability level based, at least in part, on the one or more categories of richness.

According to another embodiment, a computer-readable storage medium carries one or more sequences of one or more instructions which, when executed by one or more processors, cause, at least in part, an apparatus to cause, at least in part, an aggregation of data associated with one or more modalities of a user device. The apparatus is also caused to determine one or more categories of richness for the data associated with each one of the one or more modalities, wherein the richness is indicative of one or more parameters associated with the data user information, or a combination thereof. The apparatus is further caused to determine a user privacy vulnerability level based, at least in part, on the one or more categories of richness.

According to another embodiment, an apparatus comprises means for causing, at least in part, an aggregation of data associated with one or more modalities of a user device. The apparatus also comprises means for determining one or more categories of richness for the data associated with each one of the one or more modalities, wherein the richness is indicative of one or more parameters associated with the data user information, or a combination thereof. The apparatus further comprises means for determining a user privacy vulnerability level based, at least in part, on the one or more categories of richness.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing contextual data privacy, according to an embodiment;

FIG. 2 is a diagram of the components of a user equipment capable of data collection and analysis for determining privacy and security policies, according to an embodiment;

FIGS. 3-5 are flowcharts of processes for providing contextual data privacy, according to various embodiments;

FIGS. 6-8 illustrate examples of user interface diagrams, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing contextual data privacy are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

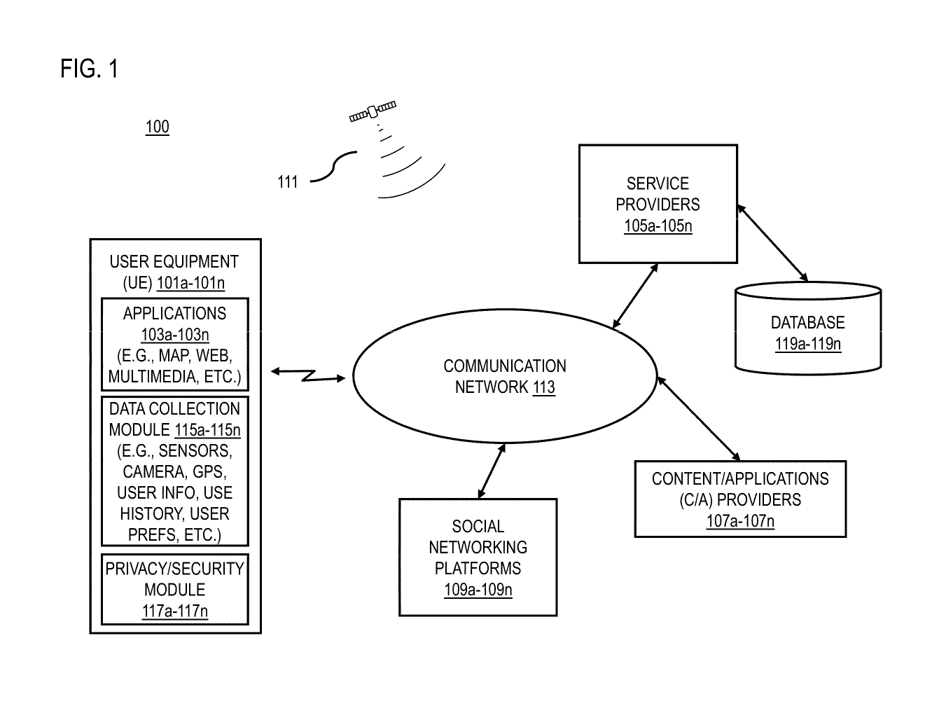

FIG. 1 is a diagram of a system capable of providing contextual data privacy, according to an embodiment. As previously discussed, mobile device (e.g., a mobile phone, a tablet, etc.) users are increasingly utilizing services (e.g., location based services, messaging services, social networking services, etc.) and applications (e.g., a map application) that collect, utilize, and upload data captured across a wide range of sensor modalities on the mobile device. For instance, the data may be associated with an accelerometer, a gyroscope, a GPS, a cell-ID, Bluetooth®, a microphone, a camera, and the like, wherein the data may include potentially personal information and/or may be utilized to derive certain information associated with the users (e.g., behavioral, real life, user history, etc.) However, because of potentially personal and sensitive nature of the data, users are increasingly wary and often are at odds with data collection activities of the service providers, application developers, and/or device manufacturers. In other words, the collection and analysis may pose a threat to the privacy of the users, where the more actively the users engage in the use of various kinds of services and applications, the higher the risk of exposing sensitive aspects of the users' life and information will be. The risk is further heightened by the fact that the data may be misused for malicious purposes. Accordingly, service providers and device manufactures face significant technical challenges to allow users to make informed decisions regarding their individual data sharing, while also presenting them with the benefits to be gained from increased data sharing.

To address, at least these problems, a system 100 of FIG. 1 introduces the capability for analyzing data associated with a user and/or a user device, determining potential risks associated with sharing the data with others (e.g., service providers, application developers, etc.), and applying a privacy policy to collecting and/or sharing the data. Various user devices (e.g., mobile phones, tablets, etc.) include various sensors and/or applications, which may collect, store, and/or share various data associated with the user, the user environment, and/or the user device. For instance, the sensors and/or the applications may be able to capture audio, video, images, location information, ambient temperature, user mood, user history, user transactions, user preferences, and the like. Further, as different users may exhibit different patterns in consumption of services and contents as well as in utilization of applications (e.g., on a user device, via a service provider, etc.), analysis of information related to the consumption and utilization can indicate various characteristics about a user and/or about a group of users. For example, the data may indicate various locations frequented by the user (e.g., a shopping area, a restaurant area, a night club area, etc.), various services requested (e.g., online shopping, gaming, etc.), various content consumptions (e.g., news feed, stock market information, entertainment, etc.), various online transactions (e.g., online commerce, finances, etc.), user information (e.g., age, gender, race, socioeconomics, etc.), commuting habits (e.g., driving fast, taking the bus, travel route, etc.), and the like. Furthermore, the data may be analyzed and/or compared to other users' data in order to infer/ascertain further information about a user and/or about a group of users. Moreover, accurate and higher instances of data associated with a first user may reveal more information (e.g., confidential and non-confidential) about the first user when compared to less accurate and lower instances of data associated with another user, which may render the first user's information more vulnerable to privacy attacks. Although the data may be utilized by service providers and application developers to provide better user services and experience, it is also possible that the data may be utilized by various entities for malicious purposes (e.g., fraud, tracking users, invasion of privacy, etc.)

In various embodiments, the system 100 can address the challenge of protecting privacy of sensitive and confidential user data by introducing methods for determining the vulnerabilities of any given user, with respect to data collected by various sensors of a user device. Since different user data (e.g., via physical and/or virtual sensors, applications, etc.) may expose different information about each user, the system 100 can determine data richness and/or contextual vulnerability for a given user and provide privacy protection by monitoring and identifying sensor and/or application data and then determine/apply a sampling and/or a filtering process that can effectuate the protection. Further, the system 100 can determine contextual vulnerability based on the data richness and/or if the composite score exceeds a predetermined level (as determined empirically, based on the distribution of the composite scores in the general population of the service users) for a given user. Furthermore, knowledge of contextual vulnerability may be utilized to personalize application, content, and/or service offerings to the user in order to assist the user to avoid revealing the user's vulnerabilities to various entities of the system 100 (e.g., application developers, content providers, third party service providers, etc.) For instance, if a user “X” is deemed to be exposing sensitive, private, and/or confidential information through location data, then the user may be advised to and/or may choose to avoid services and applications requiring the collection and/or sharing of the location data. In one embodiment, the system 100 may dynamically adjust/filter sampling along modalities (e.g., sensors, applications, etc.), which have been deemed as potentially providing contextually vulnerable data, by decreasing the sampling rate of sensors utilized in the modalities.

In one embodiment, the system 100 also provides information to describe the data collection process, information about how the data is used, information regarding the benefits to be gained from a particular data sharing or collection process, and other related information. More specifically, in one embodiment, the system 100 enables the user to select the data collection and sharing scheme (e.g., private, restricted, limited data sharing, open, coarse sampling, etc.) that a user prefers or is most comfortable with. Based on the selected data collection and sharing scheme, the system 100 can determine the applications and/or services that are compliant with the selected scheme and present them to the user through, for instance, a client application installed on a user device (e.g., a mobile device.) In some embodiments, the system 100 may provision some or all of the compliant applications and services for use at the user's device. As previously noted, in one embodiment, the data collection and/or sharing schemes vary, for example, private (e.g., context data remains on the device and is not accessible to service providers), limited (e.g., context data is made available to a primary service provider through Application Programming Interfaces (APIs), but not to third-party service providers), open (e.g., third-party service providers are also allowed access to the user's data), coarse sampling (e.g., data with limited accuracy). In various use scenarios, context data (e.g., location information) may be utilized to discover and/or provide the user with access to various applications, services, or a combination thereof.

In certain embodiments, the data collection and sharing schemes may be based on security concerns, one or more cost concerns, one or more device capabilities, or a combination thereof. Once a user has activated a particular data sharing scheme, the user is informed of the scheme's defining characteristics, one or more enabled applications, one or more enabled services, or a combination thereof based on the particular data collection and/or sharing scheme. The system 100 also provides for application/service discovery by, for instance, determining a user's context and recommending a more open data sharing scheme that supports applications appropriate for the user's context.

In one use case, the various embodiments described herein can be used in an environment in which a primary service provider mediates data sharing among users and third party service providers. More particularly, a unified control interface (e.g., a context hub) is set forth, which enables the user to make the choice of whether or not the user is interested in sharing data with the primary service provider and even further to third party service providers. In the latter case, the primary service provider can, for instance, play a role in terms of, e.g., ensuring that the third party services offered to the end user are in line with the selected data collection and/or sharing schemes, privacy policies, etc.

As shown in FIG. 1, in one embodiment, the system 100 includes user equipment (UE) 101a-101n (also collectively referred to as UE 101 and/or UEs 101), which may be utilized to execute one or more applications 103a-103n (also collectively referred to as applications 103) including games, social networking, web browser, media application, user interface (UI), map application, web client, etc. to communicate with other UEs 101, one or more service providers 105a-105n (also collectively referred to as service provider 105), one or more content/applications providers 107a-107n (also collectively referred to as C/A providers 107), one or more social networking platforms 109a-109n (also collectively referred to as social networking platforms 109), GPS satellite 111, and/or with other components of a communication network 113 directly and/or over the communication network 113. In one embodiment, the UEs 101 may include data collection modules 115a-115n (also collectively referred to as data collection module 115) for determining and/or collecting data associated with the UEs 101, one or more sensors of the UE 101, one or more users of the UEs 101, applications 103, one or more content items, and the like. In one embodiment, the UEs 101 may include privacy/security modules 117a-117n (also collectively referred to PS module 117) for providing contextual data privacy. In one embodiment, the service provider 105 may include and/or have access to one or more database 119a-119n (also collectively referred to as database 119), which may include various user information, user profiles, user preferences, service provider information, other service provider information, and the like.

In one embodiment, the system 100 causes, at least in part, an aggregation of data associated with one or more modalities of a user device. In one embodiment, the data collection module 115, service provider 105, and/or applications 103 aggregate one or more instances of data associated with one or more sensors of the UE 101. In various embodiments, the one or more modalities include at least one physical sensor, at least one virtual sensor, or a combination thereof. For example, data associated with a GPS sensor (e.g., captured over a period of time) of the UE 101 is aggregated. In another example, the data associated with an audio, video, and/or environmental sensores are aggregated. In one example, the data are generated, collected, and/or shared by one or more applications on the UE 101. In various embodiments, the data is associated with a user activity (e.g., visiting pubs, attending concerts), a user location, a user content consumption (e.g., book, magazines, etc.), a user application utilization (e.g., a game application), a user history (e.g., prior travel routes), a user transaction (e.g., online shopping), user information (e.g., user preferences), or a combination thereof.

In one embodiment, the system 100 determines one or more categories of richness for the data associated with each one of the one or more modalities, wherein the richness is indicative of one or more parameters associated with the data, user information, or a combination thereof. In one embodiment, the data collection module 115, the PS module 117 and/or the service provider 105 categorize the aggregated data based on how much information the data includes, for example, associated with a given modality (e.g., GPS, audio, device information, etc.) In one embodiment, the one or more parameters include a data type, a data amount, a data privacy level, and the like. In one embodiment, the one or more categories are determined based, at least in part, relative to an overall distribution of data associated with other users' data. In various embodiment, the one or more categories of richness may include values (e.g., 1, 2, 3, etc.), labels (e.g., high, low, medium, etc.), and the like.

In one embodiment, the system 100 determines a user privacy vulnerability level based, at least in part, on the one or more categories of richness. In various embodiments, users associated with relatively rich data within any given data modality may be determined and/or associated with higher risk of privacy vulnerability level, wherein the data may be utilized to infer privacy sensitive information pertaining to the user. For example, a rich category related to a user's location data (e.g., GPS, cell-ID, etc.) can indicate that the user location information may enable other parties to determine and/or infer various information associated with the user, for instance, user location, a demographic profile of the user, travel routes, possible establishments visited, place of residence, place of employment, and the like.

In one embodiment, the system 100 determines at least one composite score for the aggregated data associated with each one of the one or more modalities based, at least in part, on the one or more categories of richness, the one or more parameters, or a combination thereof. In various embodiments, the composite score may be calculated for all data types associated with a user and/or a user device. For instance, the data collection module 115 may collect various data samples associated with various sensors such as Bluetooth®, an accelerometer, a barometer, a camera, a microphone, a GPS, a cell-ID, and wireless local area network (WLAN). In various embodiments, one or more attributes may be utilized to calculate the composite score (e.g., a data richness score) for each of the modalities associated with a user and/or a user device, wherein the attributes may include an average data sample size, a maximum data sample size, an average data sampling rate, an average amount of data samples acquired per time unit, a total number of unique values contained by the data samples, (e.g. number of unique Bluetooth ID's contained by the Bluetooth data samples).

In one embodiment, the system 100 determines at least one privacy policy based, at least in part, on the at least one composite score. In one embodiment, the PS module 117 determines one or more privacy policies based on at least one composite score associated with the one or more aggregated data samples. For example, one or more privacy policies for the aggregated data associated with a GPS sensor, an audio sensor, a camera, and the like. In various embodiments, the at least one privacy policy is based, at least in part, on one or more criteria associated with a data sharing process, a data collecting process, or a combination thereof. For example, the data may be shared by one or more applications via one or more processes with one or more other applications, one or more service providers, one or more other users, and the like. In another example, the data may be collected by one or more applications, one or more sensors, one or more service providers, and the like.

In one embodiment, the system 100 determines at least one sampling process for the data based, at least in part, on the at least one composite score, the at least one privacy policy, or a combination thereof. In various embodiments, the data may be sampled/collected via various sensors, modules, and/or applications at different sampling rates, wherein the sampling rates may be determined by various applications, service providers, and the like, for various utilizations. For example, a given application may require a certain sampling rate/granularity of GPS data in order to provider certain location-based services. In one embodiment, the PS module 117 and/or the service provider 105 may adjust the one or more sampling rates based, at least in part, on the at least one privacy policy, for example, reduce the sampling rate, sampling size, filter the sample size, and the like in order to reduce accuracy of the data samples (e.g., reduced location accuracy).

In one embodiment, the system 100 causes, at least in part, an initiation of a sharing, a filtering, or a combination thereof of the data based, at least in part, on the at least one composite score, the at least one privacy policy, or a combination thereof. In one embodiment, the PS module 117 may a process for sharing of the data based on the composite score, the privacy policy, user defined parameters, and the like. For example, one or more applications may request certain data/information associated with the user and/or the user device, wherein the PS module 117 may facilitate the data sharing based on the privacy policy. In one example, the service provider 105 may facilitate filtering and/or sharing of the data with one or more other service providers based on the composite score and/or the privacy policy.

In one embodiment, the system 100 causes, at least in part, a presentation of the at least one privacy policy to the user. In one embodiment, the PS module 117 and/or the service provider 105 may determine one or more privacy policies for data associated with one or more sensors and/or applications of a user device, and present the one or more privacy policies to the user of the user device for user consideration (e.g., approve, modify, select, etc.)

In one embodiment, the system 100 determines an input for selecting, for confirming, or a combination thereof of the at least one privacy policy. In various embodiments, a user via a UI may select, modify, reject, confirm, etc. the one or more privacy policies presented by the PS module 117 and/or the service provider 105, which may be utilized for sharing, storing, collecting, and the like data associated with the user and/or the user device.

In one embodiment, the system 100 causes, at least in part, an initiation of the application of the at least one privacy policy based, at least in part, on the input. For example, the PS module 117, the applications 103, and/or the service provider 105 may apply one or more privacy policies determined and/or selected by the user. In one embodiment, one or more privacy policies utilized for a different data set may be applied to one or more other data sets. In various embodiments, the one or more privacy policies may be applied manually (e.g., by a user) and/or substantially automatically (e.g., by the PS module 117, a service provider, etc.)

In one embodiment, the system 100 causes, at least in part, at least one comparison of the data, the user information, or a combination thereof with other data, other user information, or a combination thereof associated with one or more other users, one or more other user devices, or a combination thereof. In one embodiment, the service provider 105 may compare data associated with a user and/or a user device with data associated with one or more other users and/or user devices, wherein the data may be the aggregated data and/or prior to the aggregation. For example, GPS data associated with a user may be compared to GPS data associated with one or more other users. In one embodiment, the user and the one or more other users may have one or more characteristics in common, for example, geographical location, user information, user profile, content consumption, application utilization, and the like. In one embodiment, the data collection module 115 and/or the PS module 117 may request a service provider to perform the one or more comparisons.

In one embodiment, the system 100 determines the at least one composite score, the at least one privacy policy, or a combination thereof based, at least in part, on the at least one comparison. In various embodiments, the service provider 105 may determine that the user has a similar or a different composite score than one or more other users. In one embodiment, the PS module 117 may receive information from one or more service providers associated with the one or more other users for determining the composite score.

In one embodiment, the system 100 determines contextual information associated with the data. In various embodiments, the data collection module 115, the applications 103, and/or the PS module 117 may analyze the data for determining contextual information associated with the data, for example, the data may indicate and/or contain information related to content type, application type, user information, device information, required data, service provider, content provider, and the like.

In one embodiment, the system 100 determines the privacy vulnerability level based, at least in part, on the at least one composite score, the contextual information, or a combination thereof. In various embodiments, the PS module 117 and/or the service provider 105 may determine one or more privacy vulnerability risks based on the composite score associated with the data. For example, the composite score may indicate a high risk level (e.g., level 1), wherein the data may indicate sensitive personal information. In one embodiment, the contextual information may indicate one or more information items indicative of sensitive user information.

In one embodiment, the system 100 determines at least one request for the data from one or more service providers, one or more applications, one or more content items, or a combination thereof. In various embodiments, one or more service providers (e.g., a location-based service provider) may request for information associated with one or more contents and/or applications associated with the user and/or the user device. In various embodiments, one or more applications (e.g., a game application) and/or content items (e.g., a magazine) may request the data items. In one embodiment, a service provider may determine one or more requests from one or more other service providers.

In one embodiment, the system 100 causes, at least in part, a presentation of at least one notification of at least one potential privacy policy violation based, at least in part, on the at least one request, on the at least one composite score, the privacy vulnerability level, or a combination thereof to the user. In various embodiments, the PS module 117 and/or the service provider 105 may determine and/or present one or more privacy policy violation notifications based on a request for data (e.g., from an application, from a service provider, etc.) associated with a user and/or a user device data, which may be deemed sensitive and/or restricted. In one embodiment, the presentation of a privacy policy violation notification may be based on a composite score associated with the data. For example, a composite score indicating a high privacy risk level (e.g., level 1) may be presented to the user, wherein the user may initiate one or more actions.

Although various embodiments discuss providing contextual data privacy, it is contemplated that the various embodiments described herein are applicable to providing data privacy applicable to any type of data available at a device. In one embodiment, the contextual data refers, for instance, to data that indicates state of the device, state of the device environment and/or the inferred state of a user of the device. The states indicated by the context are, for instance, described according to one or more “contextual parameters” including time, recent applications running on the device, recent World Wide Web pages presented on the device, keywords in current communications (such as emails, SMS messages, IM messages), current and recent locations of the device (e.g., from a global positioning system, GPS, or cell tower identifier), environment temperature, ambient light, movement, transportation activity (e.g., driving a car, riding the metro, riding a bus, walking, cycling, etc.), activity (e.g., eating at a restaurant, drinking at a bar, watching a movie at a cinema, watching a video at home or at a friend's house, exercising at a gymnasium, traveling on a business trip, traveling on vacation, etc.), emotional state (e.g., happy, busy, calm, rushed, etc.), interests (e.g., music type, sport played, sports watched), contacts, or contact groupings (e.g., family, friends, colleagues, etc.), among others, or some combination thereof.

By way of example, the communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 may be any type of mobile terminal, fixed terminal, or portable terminal including a mobile handset, station, unit, device, healthcare diagnostic and testing devices, product testing devices, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs can support any type of interface to the user (such as “wearable” circuitry, etc.). Further, the UEs 101 may include various sensors for collecting data associated with a user, a user's environment, and/or with a UE 101, for example, the sensors may determine and/or capture audio, video, images, atmospheric conditions, device location, user mood, ambient lighting, user biometric information, device movement speed and direction, and the like.

By way of example, the UEs 101, the service provider 105, the C/A providers 107, and the social networking platforms 109 communicate with each other and other components of the communication network 113 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, one or more entities of the system 100 may interact according to a client-server model with the applications 103 and/or the PS module 117 of the UE 101. According to the client-server model, a client process sends a message including a request to a server process, and the server process responds by providing a service (e.g., context-based grouping, social networking, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

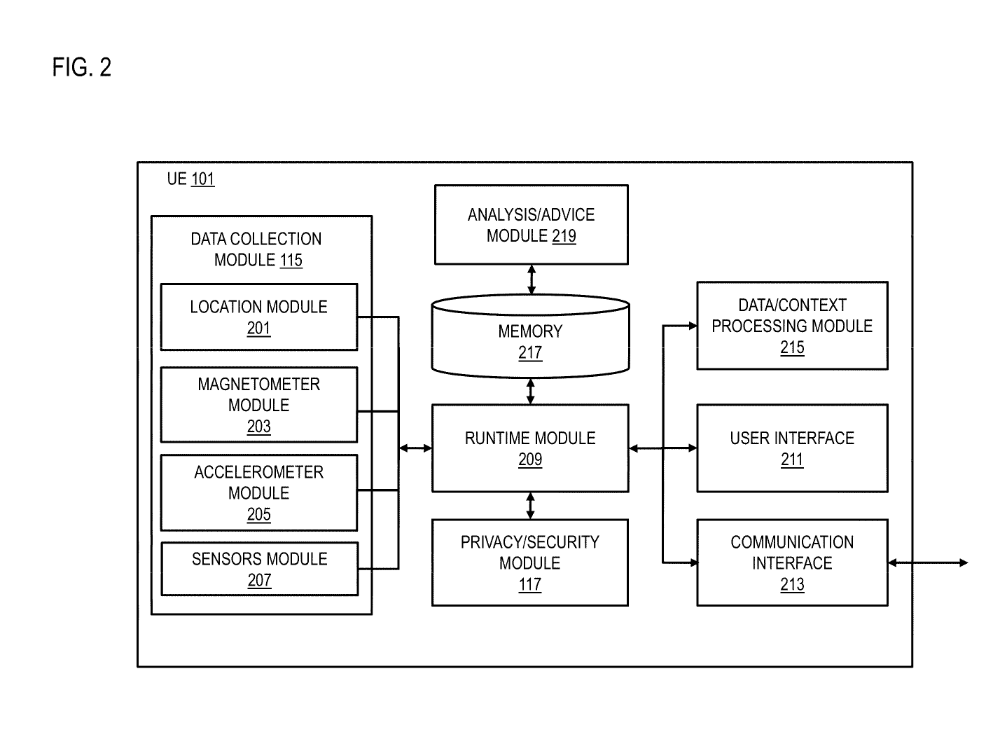

FIG. 2 is a diagram of the components of a user equipment capable of data collection and analysis for determining privacy and security policies, according to an embodiment. By way of example, a UE 101 includes one or more components for receiving, collecting, generating, and/or analyzing data to determine privacy and security policies for the data. It is contemplated that the functions of these components may be combined in one or more components or performed by other components of equivalent functionality. In this embodiment, the UE 101 includes a data collection module 115 that may include one or more location modules 201, magnetometer modules 203, accelerometer modules 205, and sensors modules 207. Further, the UE 101 may also include a runtime module 209 to coordinate the use of other components of the UE 101, a user interface 211, a communication interface 213, a data/context processing module 215, memory 217, and analysis/advice module 219. The applications 103 of the UE 101 can execute on the runtime module 209 utilizing the components of the UE 101.

The location module 201 can determine a user's location, for example, via location of a UE 101. The user's location can be determined by a triangulation system such as GPS, assisted GPS (A-GPS), Cell of Origin, or other location extrapolation technologies. Standard GPS and A-GPS systems can use satellites 111 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 217 and are available to the PS module 117, the service provider 105, and/or to other entities of the system 100 via the communication interface 213. Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 217, made available to other modules and/or applications 103 of the UE 101, and/or transmitted via the communication interface 213 to one or more entities of the system 100.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In certain embodiments, the magnetometer module 203 and accelerometer module 205 can be means for ascertaining a perspective of a user. This perspective information may be stored in the memory 217, made available to other modules and/or applications 103 of the UE 101, and/or sent to one or more entities of the system 100.

In various embodiments, the sensors module 207 may include various sensors for detecting and/or capturing data associated with the user and/or the UE 101. For example, the sensors module 207 may include sensors for capturing environmental (e.g., atmospheric) conditions, audio, video, images, location information, temperature, user biometric data, user mood (e.g., hungry, angry, tired, etc.), user interactions with the UEs 101, and the like. In certain embodiments, information collected from and/or by the data collection module 115 can be retrieved by the runtime module 209, stored in memory 217, made available to other modules and/or applications 103 of the UE 101, and/or sent to one or more entities of the system 100.

The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc.

In one embodiment, the communication interface 213 can be used to communicate with one or more entities of the system 100. Certain communications can be via methods such as an internet protocol, messaging (e.g., SMS, MMS, etc.), or any other communication method (e.g., via the communication network 113). In some examples, the UE 101 can send context information associated with the UE 101 to the service provider 105, C/A providers 107, and/or the social networking platforms 109.

The data/context processing module 215 may be utilized in determining context information from the data collection module 115 and/or applications 103 executing on the runtime module 209. For example, it can determine user activity, content consumption, application and/or service utilization, user information, type of information included in the data, information that may be inferred from the data, and the like. The data may be shared with the PS module 117, the applications 103, and/or caused to be transmitted, via the communication interface 213, to the service provider 105 and/or to other entities of the system 100. The data/context processing module 215 may additionally be utilized as a means for determining information related to the user, various data, the UEs 101, and the like. Further, data/context processing module 215, for instance, may manage (e.g., organizes) the collected data based on general characteristics, rules, logic, algorithms, instructions, etc. associated with the data. In certain embodiments, the data/context processing module 215 can infer higher level context information from the context data such as favorite locations, significant places, common activities, interests in products and services, etc.

In one embodiment, the analysis/advice module 219 may analyze the collected data in order to determine data richness, one or more composite scores based on one or more algorithms, and/or to determine advice for the user based on the results of the analysis. Such analysis and/or advice may be performed by the UE 101 and/or by the service provider 105, for example, via the communication interface 213.

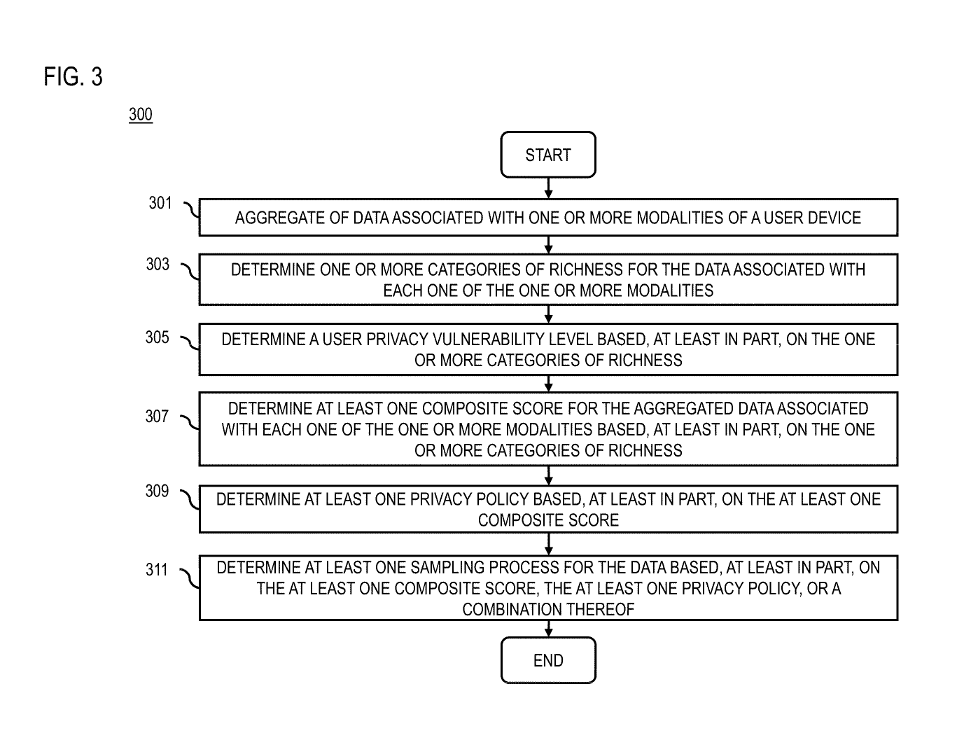

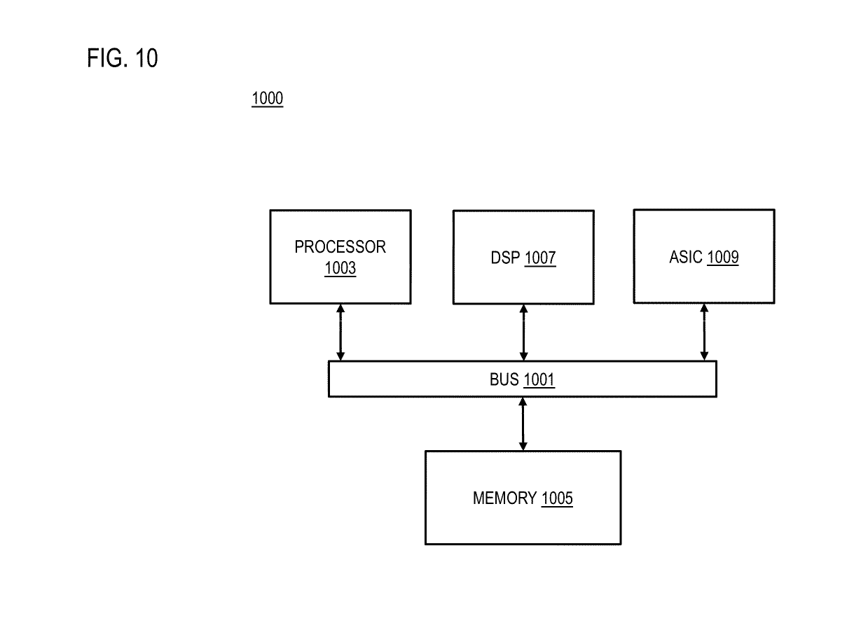

FIG. 3 is a flowchart of a process for, at least, aggregating data, determining a vulnerability level, and determining a privacy policy, according to an embodiment. In one embodiment, the PS module 117, the data collection module 115, and/or the applications 103 perform the process 300 and are implemented in, for instance, a chip set including a processor and a memory as shown in FIG. 10. As such, the PS module 117 and/or the applications 103 can provide means for accomplishing various parts of the process 300 as well as means for accomplishing other processes in conjunction with other components of the system 100. Throughout this process, the PS module 117 is referred to as completing various portions of the process 300, however, it is understood that the UE 101 can perform some of and/or all of the process steps. Further, in various embodiments, the PS module 117 may be referred to as implemented on a UE 101, however, it is understood that all or portions of the PS module 117 may be implemented in one or more entities of the system 100.

In step 301, the data collection module 115 and/or the service provider 105 causes, at least in part, an aggregation of data associated with one or more modalities of a user device. In one embodiment, the aggregated data includes one or more instances of data associated with one or more sensors of the UE 101. In various embodiments, the one or more modalities include at least one physical sensor, at least one virtual sensor, or a combination thereof. For example, data associated with a GPS sensor (e.g., captured over a period of time) of the UE 101 is aggregated. In another example, the data associated with an audio, video, and/or environmental sensores are aggregated. In one example, the data are generated, collected, and/or shared by one or more applications on the UE 101. In various embodiments, the data is associated with a user activity (e.g., visiting pubs, attending concerts), a user location, a user content consumption (e.g., book, magazines, etc.), a user application utilization (e.g., a game application), a user history (e.g., prior travel routes), a user transaction (e.g., online shopping), user information (e.g., user preferences), or a combination thereof.

In step 303, the data collection module 115 and/or the service provider 105 determines one or more categories of richness for the data associated with each one of the one or more modalities, wherein the richness is indicative of one or more parameters associated with the data, user information, or a combination thereof. In one embodiment, the data collection module 115, the PS module 117 and/or the service provider 105 categorize the aggregated data based on how much information the data includes, for example, associated with a given modality (e.g., GPS, audio, device information, etc.) In one embodiment, the one or more parameters include a data type, a data amount, a data privacy level, and the like. In one embodiment, the one or more categories are determined based, at least in part, relative to an overall distribution of data associated with other users' data. In various embodiment, the one or more categories of richness may include values (e.g., 1, 2, 3, etc.), labels (e.g., high, low, medium, etc.), and the like.

In step 305, the PS module 117 and/or the service provider 105 determines a user privacy vulnerability level based, at least in part, on the one or more categories of richness. In various embodiments, users associated with relatively rich data within any given data modality may be determined and/or associated with higher risk of privacy vulnerability level, wherein the data may be utilized to infer privacy sensitive information pertaining to the user. For example, a rich category related to a user's location data (e.g., GPS, cell-ID, etc.) can indicate that the user location information may enable other parties to determine and/or infer various information associated with the user, for instance, user location, a demographic profile of the user, travel routes, possible establishments visited, place of residence, place of employment, and the like.

In step 307, the data collection module 115 and/or the service provider 105 determines at least one composite score for the aggregated data associated with each one of the one or more modalities based, at least in part, on the one or more categories of richness, the one or more parameters, or a combination thereof. In various embodiments, the composite score may be calculated for all data types associated with a user and/or a user device. For instance, the data collection module 115 may collect various data samples associated with various sensors such as Bluetooth®, an accelerometer, a barometer, a camera, a microphone, a GPS, a cell-ID, and wireless local area network (WLAN). In various embodiments, one or more attributes may be utilized to calculate the composite score (e.g., a data richness score) for each of the modalities associated with a user and/or a user device, wherein the attributes may include an average data sample size, a maximum data sample size, an average data sampling rate, an average amount of data samples acquired per time unit, a total number of unique values contained by the data samples, (e.g. number of unique Bluetooth ID's contained by the Bluetooth data samples).

In step 309, the PS module 117 determines at least one privacy policy based, at least in part, on the at least one composite score. In one embodiment, the PS module 117 determines one or more privacy policies based on at least one composite score associated with the one or more aggregated data samples. For example, one or more privacy policies for the aggregated data associated with a GPS sensor, an audio sensor, a camera, and the like. In various embodiments, the at least one privacy policy is based, at least in part, on one or more criteria associated with a data sharing process, a data collecting process, or a combination thereof. For example, the data may be shared by one or more applications via one or more processes with one or more other applications, one or more service providers, one or more other users, and the like. In another example, the data may be collected by one or more applications, one or more sensors, one or more service providers, and the like.

In step 311, the PS module 117 and/or the data collection module 115 determines at least one sampling process for the data based, at least in part, on the at least one composite score, the at least one privacy policy, or a combination thereof. In various embodiments, the data may be sampled/collected via various sensors, modules, and/or applications at different sampling rates, wherein the sampling rates may be determined by various applications, service providers, and the like, for various utilizations. For example, a given application may require a certain sampling rate/granularity of GPS data in order to provider certain location-based services. In one embodiment, the PS module 117 and/or the service provider 105 may adjust the one or more sampling rates based, at least in part, on the at least one privacy policy, for example, reduce the sampling rate, sampling size, filter the sample size, and the like in order to reduce accuracy of the data samples (e.g., reduced location accuracy).

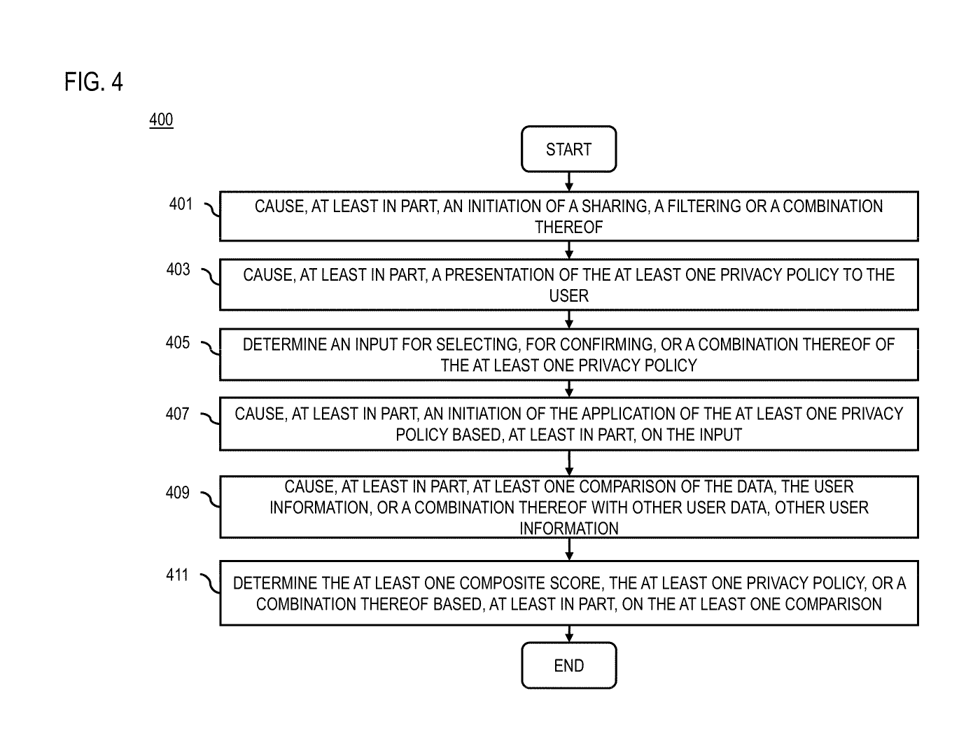

FIG. 4 is a flowchart of a process for, at least, applying a privacy policy, sharing, and filtering the data, according to an embodiment. In one embodiment, the PS module 117 and/or the applications 103 perform the process 400 and are implemented in, for instance, a chip set including a processor and a memory as shown in FIG. 10. As such, the PS module 117 and/or the applications 103 can provide means for accomplishing various parts of the process 400 as well as means for accomplishing other processes in conjunction with other components of the system 100. Throughout this process, the PS module 117 is referred to as completing various portions of the process 400, however, it is understood that the UE 101 can perform some of and/or all of the process steps. Further, in various embodiments, the PS module 117 may be referred to as implemented on a UE 101, however, it is understood that all or portions of the PS module 117 may be implemented in one or more entities of the system 100.

In step 401, the PS module 117 and/or the service provider 105 causes, at least in part, an initiation of a sharing, a filtering, or a combination thereof of the data based, at least in part, on the at least one composite score, the at least one privacy policy, or a combination thereof. In one embodiment, the PS module 117 may a process for sharing of the data based on the composite score, the privacy policy, user defined parameters, and the like. For example, one or more applications may request certain data/information associated with the user and/or the user device, wherein the PS module 117 may facilitate the data sharing based on the privacy policy. In one example, the service provider 105 may facilitate filtering and/or sharing of the data with one or more other service providers based on the composite score and/or the privacy policy.

In step 403, the PS module 117 and/or the service provider 105 causes, at least in part, a presentation of the at least one privacy policy to the user. In one embodiment, the PS module 117 and/or the service provider 105 may determine one or more privacy policies for data associated with one or more sensors and/or applications of a user device, and present the one or more privacy policies to the user of the user device for user consideration (e.g., approve, modify, select, etc.)

In step 405, the PS module 117 and/or the service provider 105 determines an input for selecting, for confirming, or a combination thereof of the at least one privacy policy. In various embodiments, a user via a UI may select, modify, reject, confirm, etc. the one or more privacy policies presented by the PS module 117 and/or the service provider 105, which may be utilized for sharing, storing, collecting, and the like data associated with the user and/or the user device.

In step 407, the PS module 117 causes, at least in part, an initiation of the application of the at least one privacy policy based, at least in part, on the input. For example, the PS module 117, the applications 103, and/or the service provider 105 may apply one or more privacy policies determined and/or selected by the user. In one embodiment, one or more privacy policies utilized for a different data set may be applied to one or more other data sets. In various embodiments, the one or more privacy policies may be applied manually (e.g., by a user) and/or substantially automatically (e.g., by the PS module 117, a service provider, etc.)

In step 409, the data collection module 115 and/or the service provider 105 causes, at least in part, at least one comparison of the data, the user information, or a combination thereof with other data, other user information, or a combination thereof associated with one or more other users, one or more other user devices, or a combination thereof. In one embodiment, the service provider 105 may compare data associated with a user and/or a user device with data associated with one or more other users and/or user devices, wherein the data may be the aggregated data and/or prior to the aggregation. For example, GPS data associated with a user may be compared to GPS data associated with one or more other users. In one embodiment, the user and the one or more other users may have one or more characteristics in common, for example, geographical location, user information, user profile, content consumption, application utilization, and the like. In one embodiment, the data collection module 115 and/or the PS module 117 may request a service provider to perform the one or more comparisons.

In step 411, the data collection module 115 and/or the service provider 105 determines the at least one composite score, the at least one privacy policy, or a combination thereof based, at least in part, on the at least one comparison. In various embodiments, the service provider 105 may determine that the user has a similar or a different composite score than one or more other users. In one embodiment, the PS module 117 may receive information from one or more service providers associated with the one or more other users for determining the composite score.

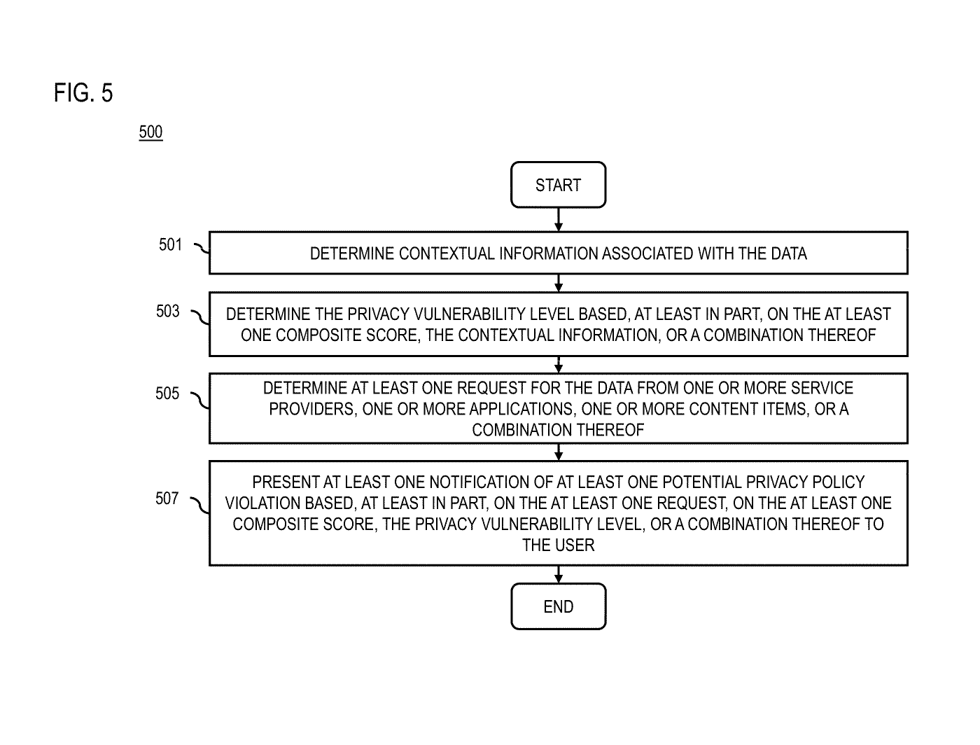

FIG. 5 is a flowchart of a process for, at least, determining contextual information and presenting notification of a potential privacy policy violation, according to an embodiment. In one embodiment, the PS module 117 and/or the applications 103 perform the process 500 and are implemented in, for instance, a chip set including a processor and a memory as shown in FIG. 10. As such, the PS module 117 and/or the applications 103 can provide means for accomplishing various parts of the process 500 as well as means for accomplishing other processes in conjunction with other components of the system 100. Throughout this process, the PS module 117 is referred to as completing various portions of the process 500, however, it is understood that the UE 101 can perform some of and/or all of the process steps. Further, in various embodiments, the PS module 117 may be referred to as implemented on a UE 101, however, it is understood that all or portions of the PS module 117 may be implemented in one or more entities of the system 100.

In step 501, the data collection module 115 and/or the service provider 105 determines contextual information associated with the data. In various embodiments, the data collection module 115, the applications 103, and/or the PS module 117 may analyze the data for determining contextual information associated with the data, for example, the data may indicate and/or contain information related to content type, application type, user information, device information, required data, service provider, content provider, and the like.

In step 503, the PS module 117 determines the privacy vulnerability level based, at least in part, on the at least one composite score, the contextual information, or a combination thereof. In various embodiments, the PS module 117 and/or the service provider 105 may determine one or more privacy vulnerability risks based on the composite score associated with the data, for example, the composite score may indicate a high risk level (e.g., level 1), wherein the data may indicate sensitive personal information. In one embodiment, the contextual information may indicate one or more information items indicative of sensitive user information.

In step 505, the data collection module 115 determines at least one request for the data from one or more service providers, one or more applications, one or more content items, or a combination thereof. In various embodiments, one or more service providers (e.g., a location-based service provider) may request for information associated with one or more contents and/or applications associated with the user and/or the user device. In various embodiments, one or more applications (e.g., a game application) and/or content items (e.g., a magazine) may request the data items. In one embodiment, a service provider may determine one or more requests from one or more other service providers.

In step 507, the PS module 117 and/or the service provider 105 causes, at least in part, a presentation of at least one notification of at least one potential privacy policy violation based, at least in part, on the at least one request, on the at least one composite score, the privacy vulnerability level, or a combination thereof to the user. In various embodiments, the PS module 117 and/or the service provider 105 may determine and/or present one or more privacy policy violation notifications based on a request for data (e.g., from an application, from a service provider, etc.) associated with a user and/or a user device data, which may be deemed sensitive and/or restricted. In one embodiment, the presentation of a privacy policy violation notification may be based on a composite score associated with the data. For example, a composite score indicating a high privacy risk level (e.g., level 1) may be presented to the user, wherein the user may initiate one or more actions.

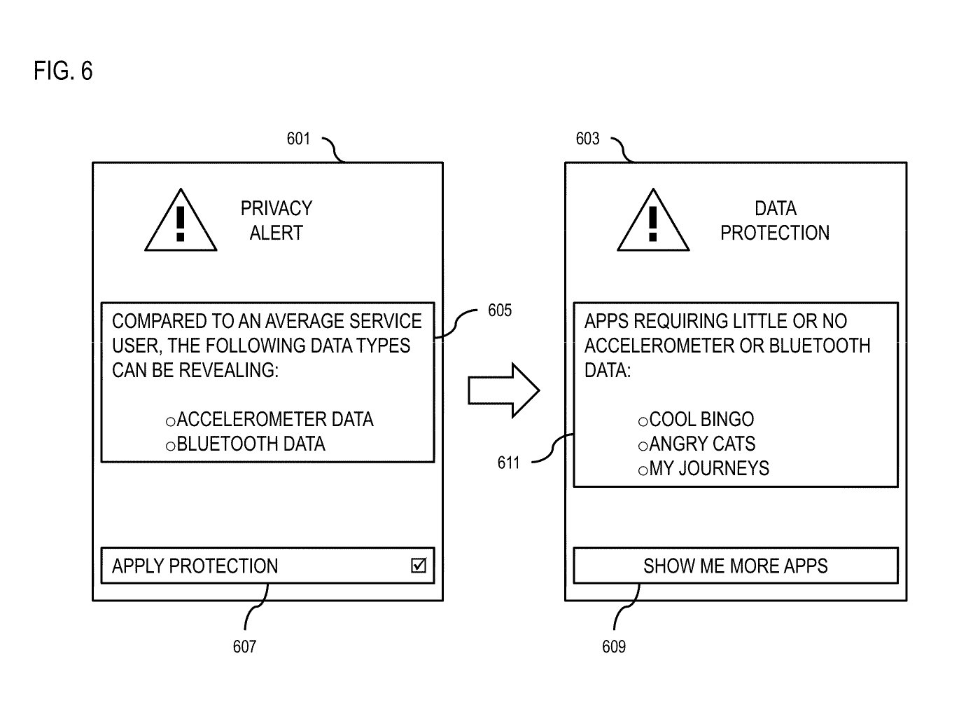

FIGS. 6-8 illustrate examples of UI diagrams for interacting with the UE 101, according to various embodiments.

FIG. 6 includes UI diagrams 601 and 603, which present information to a user of the UE 101 and can receive/detect one or more user selections. In one embodiment, during a learning period, one or more data samples may be obtained across one or more sensors of the UE 101 device. The UI diagram 601 illustrates a privacy alert presented to a user of UE 101, wherein the alert may indicate contextual vulnerability types detected during the collection and analysis of the data samples. In various embodiments, the privacy alert may be determined and/or presented by the PS module 117 and/or the analysis/advice module 219. Further, information detail 605 may provide one or more information items about one or more data types associated with one or more sensors and/or applications of the UE 101. For example, information detail 605 indicates that data types associated with an accelerometer sensor and a Bluetooth® sensor may present contextual vulnerability risks, where the user may select 607 to apply privacy and/or security protection. Furthermore, in the UI diagram 603, the user may select 609 to request for the applications 103 and/or the service provider 105 to determine and present to the user on applications, content, and/or services 611 (e.g., games, location-based services, etc.) that may require little or no data associated with the particular modalities (e.g., accelerometer and Bluetooth®) as indicated in the privacy alert 601. In general, the system 100 could present various options to the user for selecting one or more preferences to avoid applications, content, and/or services that may require certain types of data, wherein these preferences may then be utilized in future enquiries to filter services, content, and/or applications in a discovery process.

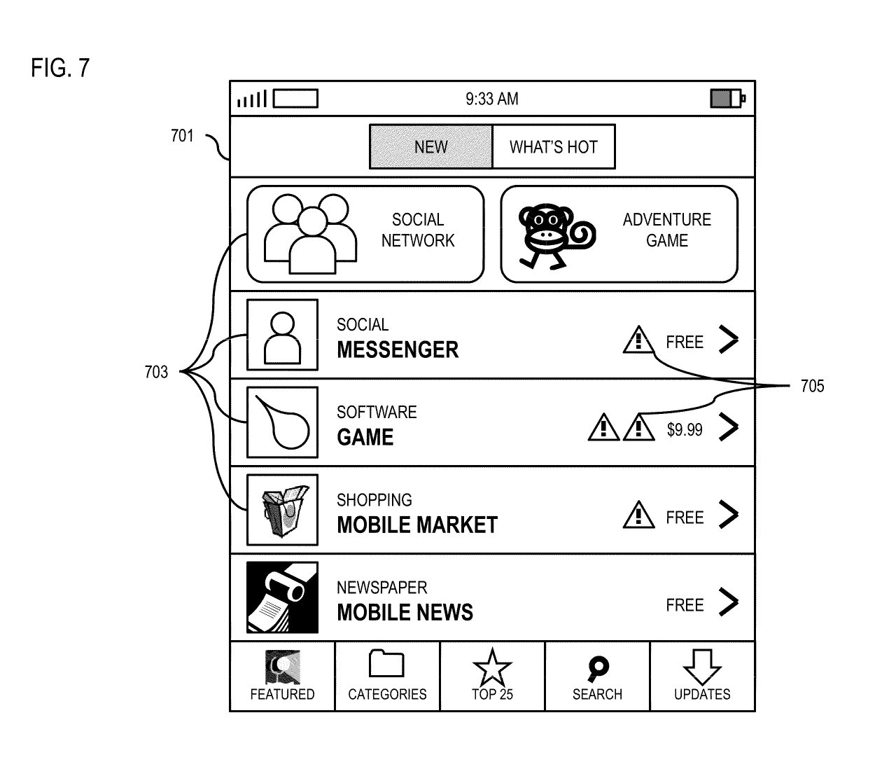

FIG. 7 shows UI diagram 701, which presents information associated with various applications and contents available at a service and/or at a content provider. In one embodiment, the contextual vulnerability information of the user may be utilized and/or shared with the service and/or the content provider in order to determine any risk levels associated with available services, applications, and/or content items 703. In one embodiment, one or more indicators 705 (e.g., icons, labels, numbers, highlighting, etc.) may be utilized to indicate to the user of a privacy risk issue associated with any of the services, applications, and/or content items 703, wherein the user may consider the privacy issues/risks before making any decisions on the service, applications, and/or the content items. Further, the privacy risk issues and warnings may be determined by the UEs 101, the service provider 105, and/or the C/A providers 107 based, at least in part, on comparing the contextual vulnerability types of the user with data which may be required by the available services, applications, and/or content items 703, wherein the data required may be determined from information and/or metadata associated with the services, applications, and/or content items 703.

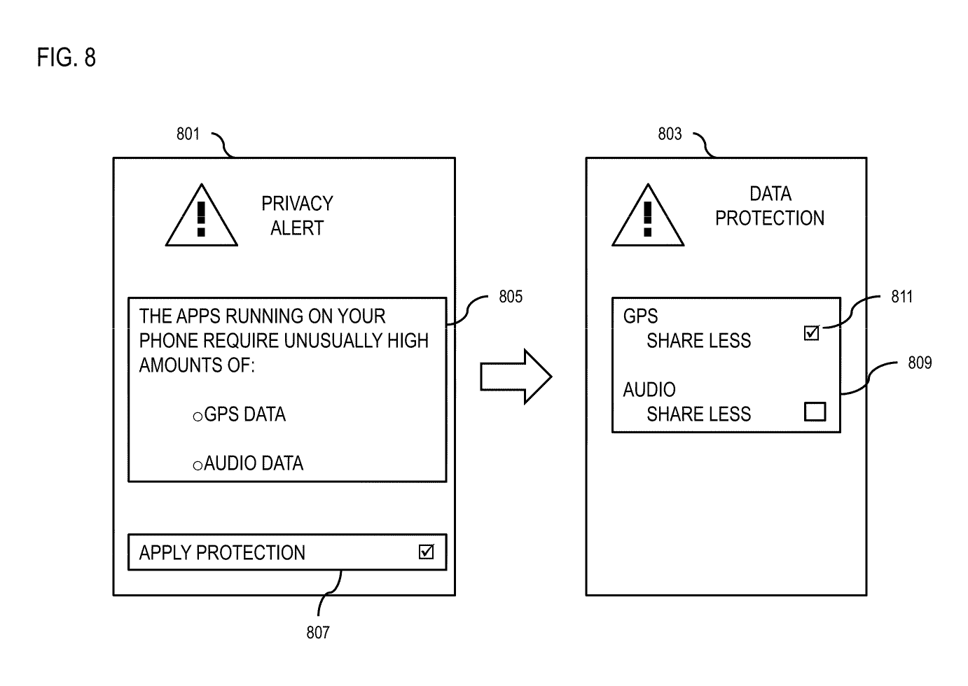

FIG. 8 depicts UI diagrams 801 and 803, which present information to a user of the UE 101 and can receive/detect one or more user selections. In one embodiment, the PS module 117 causes a presentation of a privacy alert 801 to the user, wherein the PS module 117, the data collection module 115, a client application, and/or the service provider 105 may monitor data collected by the various sensors of a UE 101 as various applications and/or services are being utilized on the UE 101. Further, the privacy alert includes information 805, which may indicate potential issues associated with one or more applications and/or services in use on the UE 101. For instance, the user may be utilizing applications “X” and “Y”, which require various sensor data samples (e.g., GPS, audio, camera, etc.) and when the applications “X” and “Y” generate and/or collect the various sensor data samples, for example, the PS module 117 and/or the service provider 105 may analyze the samples to determine one or more contextual vulnerability types. Additionally, the user may select to apply privacy protection 807 for protection against one or more contextual vulnerabilities types. In the UI 803, the user is presented with options 809 to address the identified privacy issues by applying one or more mechanisms, for example, to share less GPS data in 811, which may be accomplished by reducing sampling rates (e.g., coarser data, less accurate, etc.) In various embodiments, once the vulnerability types and related modalities have been detected, the data collection module 115, the PS module 117, and/or the service provider 105, the user may choose to apply the various protection mechanisms/configurations/selections to future data collection and/or sharing via the various modalities on the UE 101, for example, by regulating the sampling process associated with the sensors available on the UE 101. In various embodiments, the regulating of the samples may be achieved in various ways, for example, by reducing the sampling rate or by rendering the values less precise once the samples have been collected. In one embodiment, one or more applications and/or content items may be categorized as vulnerable, wherein the user may select to uninstall (e.g., stop usage) the applications and/or the content items “guilty” for the privacy threat.

The processes described herein for providing contextual data privacy may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

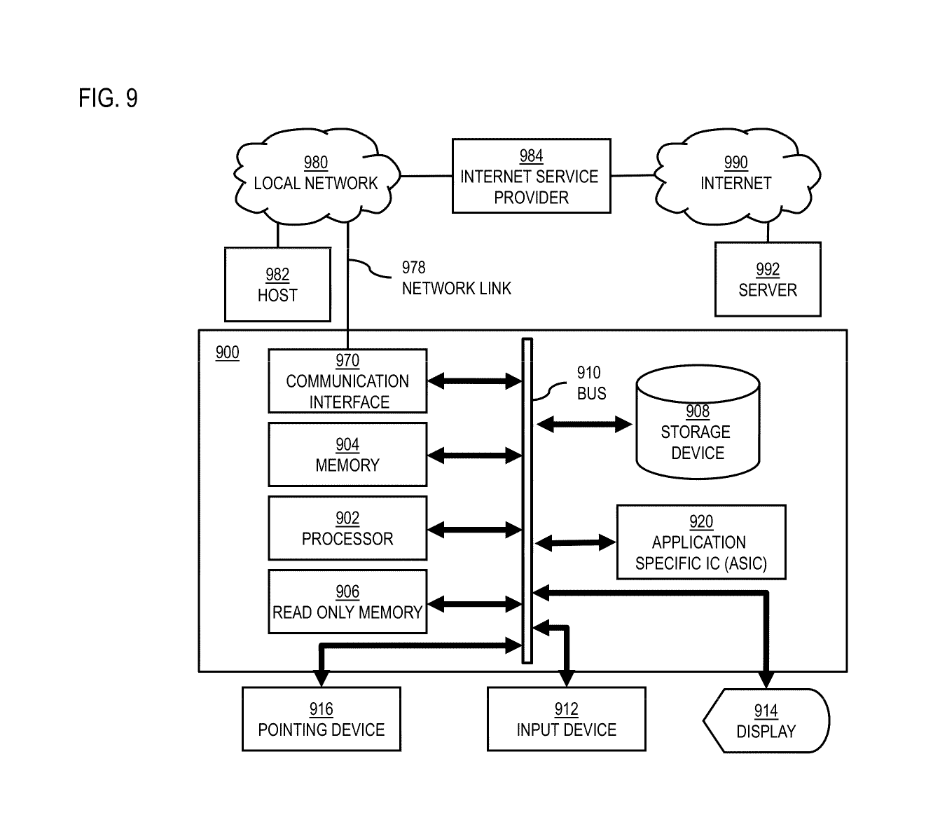

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide contextual data privacy as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing contextual data privacy.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing contextual data privacy. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing contextual data privacy. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing contextual data privacy, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 113 for providing contextual data privacy.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992. At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide contextual data privacy as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing contextual data privacy.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide contextual data privacy. The memory 1005 also stores the data associated with or generated by the execution of the inventive steps.

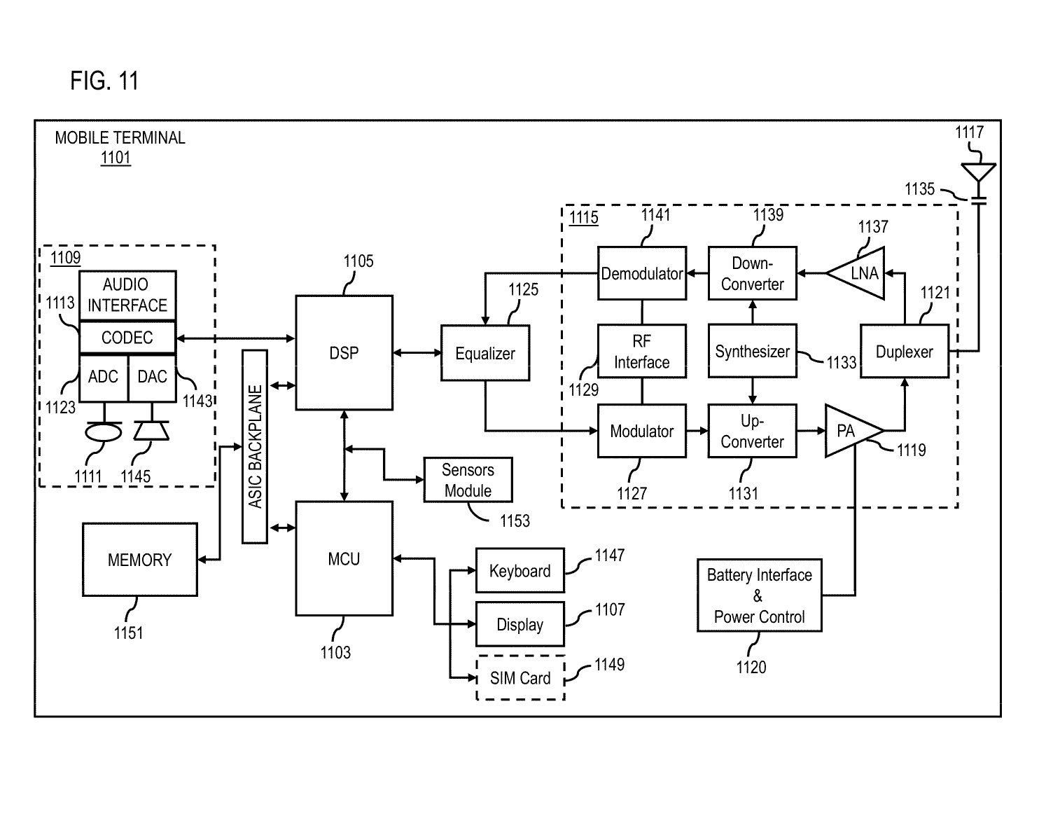

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing contextual data privacy. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing contextual data privacy. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide contextual data privacy. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Additionally, sensors module 1153 may include various sensors, for instance, a location sensor, a speed sensor, an audio sensor, an image sensor, a brightness sensor, a biometrics sensor, a directional sensor, and the like, for capturing various data associated with the mobile terminal 1101 (e.g., a mobile phone), a user of the mobile terminal 1101, an environment of the mobile terminal 1101 and/or the user, or a combination thereof, wherein the data may be collected, processed, stored, and/or shared with one or more components and/or modules of the mobile terminal 1101 and/or with one or more entities external to the mobile terminal 1101.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
an aggregation of data associated with one or more modalities of a user device;
at least one determination of one or more categories of richness for the data associated with each one of the one or more modalities, wherein the richness is indicative of one or more parameters associated with the data, user information, or a combination thereof; and
at least one determination of a user privacy vulnerability level based, at least in part, on the one or more categories of richness.

2. A method of claim 1, wherein the (1) data and/or (2) information and/or (3) at least one signal are further based, at least in part, on the following:
at least one determination of at least one composite score for the aggregated data associated with each one of the one or more modalities based, at least in part, on the one or more categories of richness, the one or more parameters, or a combination thereof;
at least one determination of at least one privacy policy based, at least in part, on the at least one composite score; and
at least one determination of at least one sampling process for the data based, at least in part, on the at least one composite score, the at least one privacy policy, or a combination thereof.

3. A method of claim 1, wherein the (1) data and/or (2) information and/or (3) at least one signal are further based, at least in part, on the following:
an initiation of a sharing, a filtering, or a combination thereof of the data based, at least in part, on the at least one composite score, the at least one privacy policy, or a combination thereof.

4. A method of claim 2, wherein the (1) data and/or (2) information and/or (3) at least one signal are further based, at least in part, on the following:
a presentation of the at least one privacy policy to the user;
at least one determination of an input for selecting, for confirming, or a combination thereof of the at least one privacy policy; and
an initiation of the application of the at least one privacy policy based, at least in part, on the input.

5. A method of claim 1, wherein the one or more modalities include at least one physical sensor, at least one virtual sensor, or a combination thereof.

6. A method of claim 2, wherein the (1) data and/or (2) information and/or (3) at least one signal are further based, at least in part, on the following:
at least one comparison of the data, the user information, or a combination thereof with other data, other user information, or a combination thereof associated with one or more other users, one or more other user devices, or a combination thereof; and
at least one determination of the at least one composite score, the at least one privacy policy, or a combination thereof based, at least in part, on the at least one comparison.

7. A method of claim 1, wherein the (1) data and/or (2) information and/or (3) at least one signal are further based, at least in part, on the following:
at least one determination of contextual information associated with the data; and
at least one determination of the privacy vulnerability level based, at least in part, on the at least one composite score, the contextual information, or a combination thereof.

8. A method of claim 1, wherein the (1) data and/or (2) information and/or (3) at least one signal are further based, at least in part, on the following:
at least one determination of at least one request for the data from one or more service providers, one or more applications, one or more content items, or a combination thereof; and
a presentation of at least one notification of at least one potential privacy policy violation based, at least in part, on the at least one request, on the at least one composite score, the privacy vulnerability level, or a combination thereof to the user.

9. A method of claim 1, wherein the data is associated with a user activity, a user location, a user content consumption, a user application utilization, a user history, a user transaction, user information, or a combination thereof.

10. A method of claim 2, wherein the at least one privacy policy is based, at least in part, on one or more criteria associated with a data sharing process, a data collecting process, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, an aggregation of data associated with one or more modalities of a user device;
determine one or more categories of richness for the data associated with each one of the one or more modalities, wherein the richness is indicative of one or more parameters associated with the data, user information, or a combination thereof; and
determine a user privacy vulnerability level based, at least in part, on the one or more categories of richness.

12. An apparatus of claim 11, wherein the apparatus is further caused to:
determine at least one composite score for the aggregated data associated with each one of the one or more modalities based, at least in part, on the one or more categories of richness, the one or more parameters, or a combination thereof;
determine at least one privacy policy based, at least in part, on the at least one composite score; and
determine at least one sampling process for the data based, at least in part, on the at least one composite score, the at least one privacy policy, or a combination thereof.

13. An apparatus of claim 11, wherein the apparatus is further caused to:
cause, at least in part, an initiation of a sharing, a filtering, or a combination thereof of the data based, at least in part, on the at least one composite score, the at least one privacy policy, or a combination thereof.

14. An apparatus of claim 12, wherein the apparatus is further caused to:
cause, at least in part, a presentation of the at least one privacy policy to the user;
determine an input for selecting, for confirming, or a combination thereof of the at least one privacy policy; and
cause, at least in part, an initiation of the application of the at least one privacy policy based, at least in part, on the input.

15. An apparatus of claim 11, wherein the one or more modalities include at least one physical sensor, at least one virtual sensor, or a combination thereof.

16. An apparatus of claim 12, wherein the apparatus is further caused to:
cause, at least in part, at least one comparison of the data, the user information, or a combination thereof with other data, other user information, or a combination thereof associated with one or more other users, one or more other user devices, or a combination thereof; and
determine the at least one composite score, the at least one privacy policy, or a combination thereof based, at least in part, on the at least one comparison.

17. An apparatus of claim 11, wherein the apparatus is further caused to:
determine contextual information associated with the data; and
determine the privacy vulnerability level based, at least in part, on the at least one composite score, the contextual information, or a combination thereof.

18. An apparatus of claim 11, wherein the apparatus is further caused to:
determine at least one request for the data from one or more service providers, one or more applications, one or more content items, or a combination thereof; and
cause, at least in part, a presentation of at least one notification of at least one potential privacy policy violation based, at least in part, on the at least one request, on the at least one composite score, the privacy vulnerability level, or a combination thereof to the user.

19. An apparatus of claim 11, wherein the data is associated with a user activity, a user location, a user content consumption, a user application utilization, a user history, a user transaction, user information, or a combination thereof.

20. An apparatus of claim 12, wherein the at least one privacy policy is based, at least in part, on one or more criteria associated with a data sharing process, a data collecting process, or a combination thereof.

21-48. (canceled)
